(19) United States
(12) Patent Application Publication
(10) Pub. No.: US 2025/0347465 A1
(43) Pub. Date: Nov. 13, 2025

(54) DUAL ELECTRODE DC ARC FURNACE

(71) Applicants: Frederik Petrus GREYLING, Middelburg (ZA); Ruan GREYLING, Middelburg (ZA)

(72) Inventors: Frederik Petrus GREYLING, Middelburg (ZA); Ruan GREYLING, Middelburg (ZA)

(21) Appl. No.: 19/205,404

(22) Filed: May 12, 2025

(30) Foreign Application Priority Data
May 13, 2024 (NL) 2037671

(51) Int. Cl. F27B 3/08; F27D 99/00

(52) U.S. Cl. CPC F27B 3/085; F27D 99/0006; F27D 2099/0023

(57) ABSTRACT

A DC arc furnace 10 comprises a vessel 12 comprising a roof 14, a base 16 and a sidewall 18. The vessel defines a chamber 20 for a body of material having an upper surface 44. An anode electrode 24 and a cathode electrode 26 extend parallel to one another and terminate a distance d from the upper surface. The anode and cathode are located on a first horizontal line 28 and define a gap between them. A first conductor 36 links a positive pole 32 to the anode and a second conductor 38 links a negative pole to the cathode. The first conductor comprises a first section 36.1 extending continuously underneath the base parallel to the first line, so that current flows in the first section in a direction A directly opposite to current flow B through the body of material between the anode and the cathode.

### CROSS-REFERENCE TO RELATED APPLICATION

This application claims priority to Netherlands Patent Application 2037671, filed on May 13, 2024, the disclosure of which is hereby incorporated by reference in its entirety.

### INTRODUCTION AND BACKGROUND

This invention relates to electric arc furnaces and more particularly to a dual electrode DC arc furnace.

A dual electrode DC arc furnace comprises a vessel comprising a base, a roof and sidewalls extending between the roof and the base. In use, the vessel holds a body of material to be processed. The body typically comprises a bath comprising a layer of molten metal and a layer of slag on the layer of molten metal so that the layer of slag provides an upper surface of the bath. A first or anode electrode extends through the roof and terminates a first distance from the upper surface. A second or cathode electrode also extends through the roof and may also terminate the first distance from the upper surface. A positive pole of a DC power supply is connected to the anode electrode by conductors comprising busbars, flexible cables and electrode arms and a negative pole of the DC power supply is similarly connected to the cathode electrode. In use, first and second arcs are formed between the anode electrode and the bath and between the cathode electrode and the bath, respectively.

DC Current flows through the vessel vertically downwards through the anode electrode and the first arc, horizontally in parallel paths in the slag and the molten metal and vertically upwards via the second arc and the cathode electrode.

According to the principles of the Biot-Savart and Lorentz electromagnetic laws, two adjacent arcs with opposite current directions (as above) repel each other, causing the arcs to diverge and an increase in the distance between their impingement points on the bath. This increase also results in an increase in length of the horizontal paths of conduction in the slag and molten metal.

According to electromagnetic theory, a current flowing through a medium, when that current passes through a transverse magnetic field, the medium experiences a transverse mechanical thrust. In the case of two arcs, that is the principle by which they repel each other. The divergent behaviour for opposite-direction currents in the two arcs takes place in the absence of background magnetisation, because each arc experiences a force in the magnetic field produced by the other. If the two arcs find themselves in a background magnetic field, such as that generated by the busbars, flexible cables and electrodes in the main DC current circuit of the furnace, the thrust on the arcs takes place by virtue of the current in the arcs reacting to the background magnetic fields as well as their mutually self-generated fields. Because the strengths of the encountered fields depend on other current-carrying members, with strongest fields produced by nearest members, the background magnetic fields will vary both in strength and vector direction. Arc behaviour therefore depends on a combination of the arc's own current magnitudes and the combined fields of background magnetisation. The relative magnitude of the summated flux from all sources in which the arcs find themselves will determine the behaviour of the arc.

Diverging arcs, particularly with unpredictable behaviour, are not desirable, because at the very least, they may cause damage to the refractory of the sidewalls. In order to counter this skewing, it is known to employ special DC arc skewing compensation circuits parallel to the electrodes and even dedicated DC power supplies to energize the compensation circuits and to de-skew the arcs. An example is disclosed in WO2021/105808. However, this solution, of course, implies additional infrastructure and cost.

### OBJECT OF THE INVENTION

Accordingly, it is an object of the present invention to provide a dual electrode DC arc furnace with which the applicant believes the aforementioned disadvantages may at least be alleviated or which may provide a useful alternative for the known furnaces.

### SUMMARY OF THE INVENTION

According to the invention there is provided a DC arc furnace comprising:
a vessel comprising a roof, a base and at least one sidewall extending between the roof and the base;
the vessel defining a chamber holding a body of material to be processed, the body having an upper surface;
a first electrode and a second electrode extending parallel to one another through the roof towards the base and terminating a distance d from the upper surface, the first and second electrodes, when viewed in plan, are located on a first horizontal line and define a gap g between them;
a DC power supply having a first pole and a second pole; and
a first conductor linking the first pole to the first electrode and a second conductor linking the second pole to the second electrode, the first conductor comprising a first section extending continuously underneath the base parallel to the first line at least across the gap, so that current flows in the first section in a direction directly opposite to current flowing through the body of material between the first electrode and the second electrode.

Surprisingly, the applicant has found that with the above arrangement of the first section of the first conductor as close as possible to the base may make any special and external compensation circuit redundant and unnecessary. It is possible that in some embodiments the known compensation circuits would have a negligible additional effect.

The first section of the first conductor may extend continuously underneath the vessel parallel to the first line from one side of the vessel to an opposite side of the vessel.

In a currently preferred embodiment, the first line and the first section of the first conductor are located in a common vertical plane.

The first section is arranged in close or proximity to the base. It is believed that the closer to the base the better.

The first section of the first conductor may comprise a high current busbar or bus tube.

A second section of the first conductor may extend vertically upwardly from the first section towards the roof of the furnace parallel with the first electrode and in close proximity to a sidewall between the second section and the first electrode.

The second section of the first conductor may also comprise high current busbar or bus tube.

A first section of the second conductor may intersect the first line and extend vertically between the base and the roof of the furnace parallel with the second electrode and in close proximity to a sidewall between the first section of the second conductor and the second electrode.

The first section of the second conductor may also comprise high current busbar or bus tube.

The first electrode may be an anode, the second electrode may be a cathode, the first pole may be a positive pole and the second pole may be a negative pole.

In other embodiments, the first electrode may a cathode, the second electrode may be an anode, the first pole may be a negative pole and the second pole may be a positive pole.

The vessel may be one of circular, square and rectangular in transverse cross section.

An intermediate voltage point, preferably a centre voltage point, between the first pole and the second pole of the power supply may be connect via a resistor to earth.

According to another aspect of the invention there is provided a method of operating a DC arc furnace comprising: a vessel comprising a roof, a base and at least one sidewall extending between the roof and the base, the vessel defining a chamber holding a body of material to be processed, the body having an upper surface; a first electrode and a second electrode extending parallel to one another through the roof towards the base and terminating a distance d from the upper surface, the first and second electrodes, when viewed in plan, are located on a first horizontal line and define a gap g between them; a DC power supply having a first pole and a second pole; and a first conductor linking the first pole to the first electrode and a second conductor linking the second pole to the second electrode, the method comprising the steps of:
causing a current in a first section of the first conductor to flow underneath the base parallel to the first line at least across the gap, so that current flows in the first section in a direction directly opposite to current flowing through the body of material between the first electrode and the second electrode.

According to another aspect of the invention there is provided a DC arc furnace comprising:
a vessel comprising a roof, a base and at least one sidewall extending between the roof and the base;
the vessel defining a chamber holding a body of material to be processed, the body having an upper surface;
a first electrode and a second electrode extending, in a normal operative configuration, parallel to one another through the roof towards the base and terminating a distance d from the upper surface, the first and second electrodes, when viewed in plan, being located on a first horizontal line and defining a gap g between them;
a DC power supply having a first pole and a second pole; and
a first conductor linking the first pole to the first electrode and a second conductor linking the second pole to the second electrode, and
an arc deflection compensation conductor extending continuously underneath the base parallel to the first line at least across the gap and carrying a DC compensation current in a direction directly opposite to DC current flowing through the body of material between the first electrode and the second electrode.

### BRIEF DESCRIPTION OF THE ACCOMPANYING DIAGRAMS

The invention will now further be described, by way of example only, with reference to the accompanying diagrams wherein:

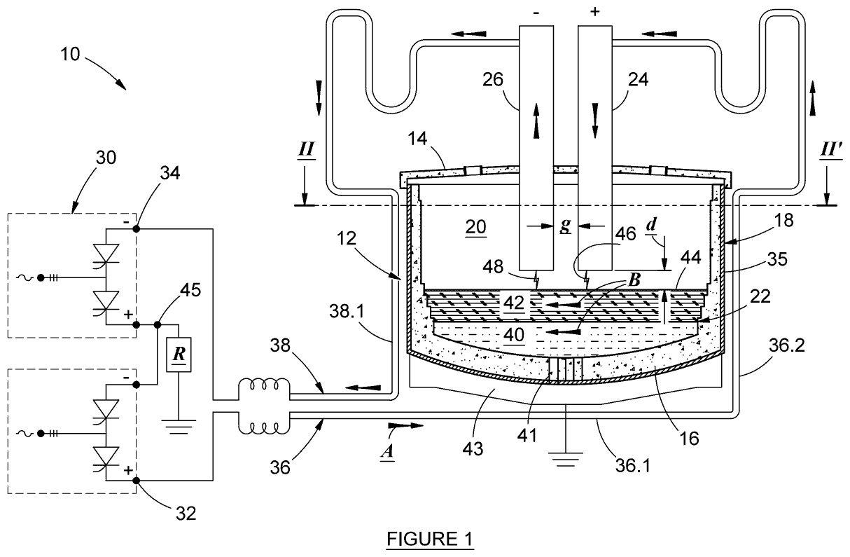

FIG. 1 is a diagrammatic elevational view in section of a first example embodiment of a dual electrode DC arc furnace;

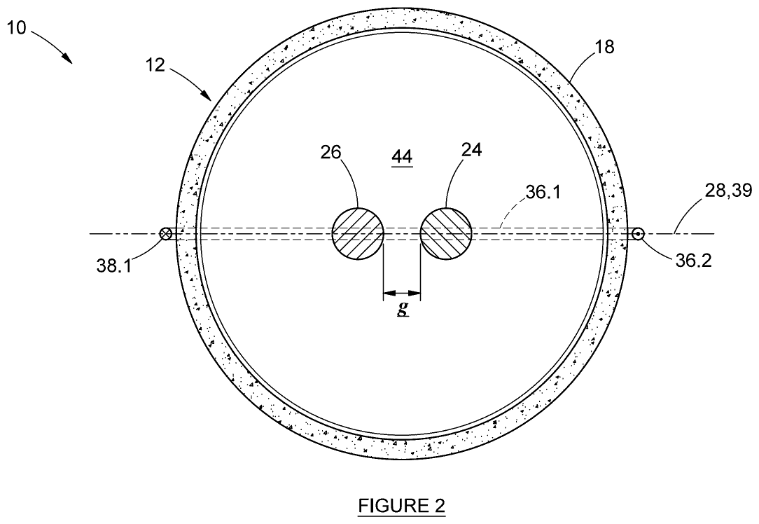

FIG. 2 is a section on line II-Il' in FIG. 1;

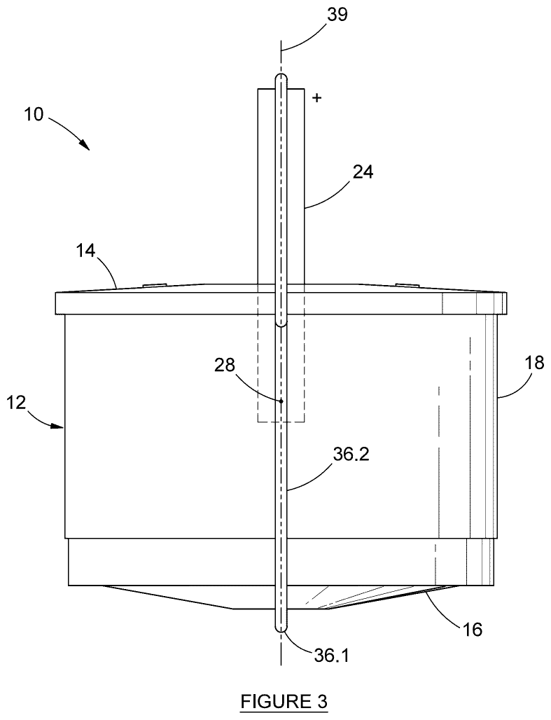

FIG. 3 is a diagrammatic side view from the right of the furnace in FIG. 1;

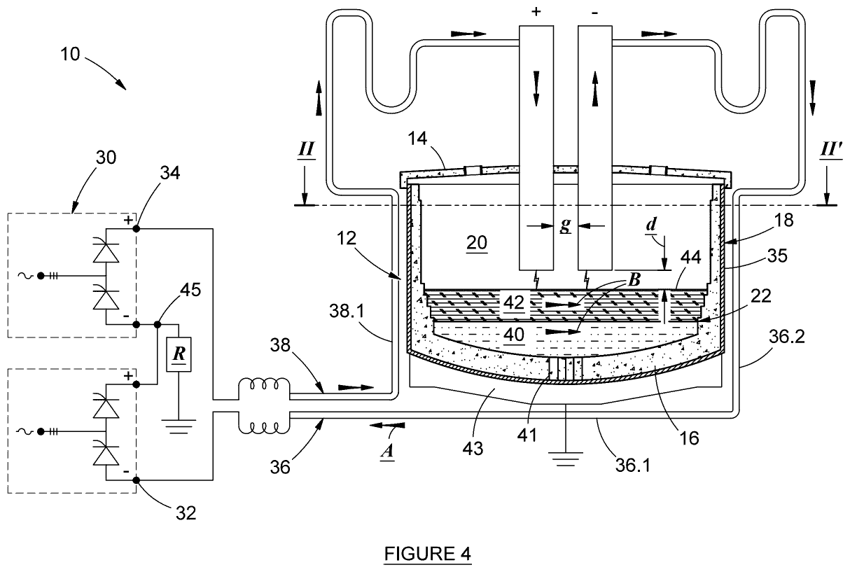

FIG. 4 is a view similar to FIG. 1 of a second example embodiment of the dual electrode DC arc furnace; and

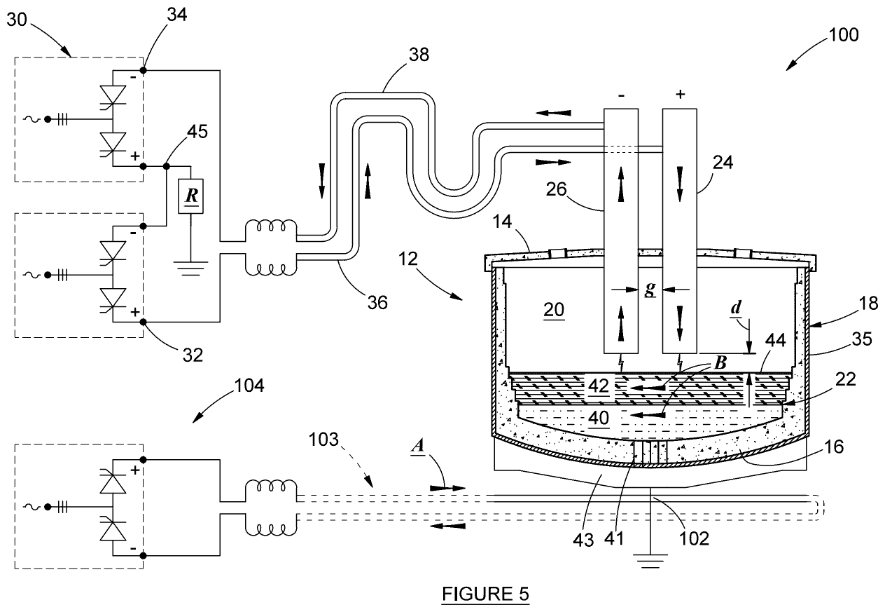

FIG. 5 is a diagrammatic elevational view in section of another example embodiment of a dual electrode DC arc furnace.

### DESCRIPTION OF A PREFERRED EMBODIMENT OF THE INVENTION

A first example embodiment of a dual electrode DC arc furnace is designated 10 in FIGS. 1 to 3.

The dual electrode DC arc furnace 10 comprises a vessel 12 comprising a roof 14, a base 16, and at least one sidewall 18 extending between the roof and the base. The vessel 12 defines a chamber 20 holding a body 22 of material to be processed. The body typically comprises a bath comprising a layer of molten metal 40 and a layer of slag 42 on the layer of molten metal, so that the layer of slag provides an upper surface 44 of the bath. A first electrode (in this example embodiment an anode) 24 and a second electrode (in this example embodiment a cathode) 26, in a normal operative configuration, extend parallel to one another through the roof towards the base. As shown in FIG. 2, when viewed in plan, the first and second electrodes are located on a first imaginary horizontal line 28 and define a gap g between them.

Referring again to FIG. 1, each of the electrodes terminate a distance d from the upper surface 44.

A DC power supply 30 has a first (in this example embodiment a positive) pole 32 and a second (in this example embodiment a negative) pole 34. A first conductor 36 links the first pole 32 to the first electrode 24 and a second conductor 38 links the second pole 34 to the second electrode 26. The first conductor comprises a first section 36.1 extending underneath the base 16 parallel to the first line 28, so that current flows in the first section 36.1 in a direction A directly opposite to a direction B of current flowing through the body 22 of material between the first electrode 24 and the second electrode 26.

The first section 36.1 extends continuously underneath the base parallel to the first line 28 at least across the gap g. However, as shown in FIGS. 1 and 2, preferably, the first section 36.1 extends continuously underneath the vessel parallel to the first line from one side of the vessel to an opposite side of the vessel. Most preferably, the first line 28 and first section 36.1 of the first conductor are located in a common vertical plane 39, as best shown in FIGS. 2 and 3.

In general, the vessel comprises a steel shell 35. The base 16 is made of refractory in known manner with a central conductive and current limiting section 41 which electrically connects the molten metal layer 40 to shell 35 and conductive structural ribs 43 of steel which are earthed as shown. The sidewalls and roof also comprise refractory in known manner.

An intermediate, preferably centre, voltage point 45 of the power supply 30 between the first pole 32 and the second pole 34 is earthed via a resistor R, with suitably selected resistance value. This resistor restricts the maximum fault current in the event of any conductor 36, 38 developing an earth fault, such as insulation failure or accidental contact between a conductor or an electrode 24, 26 with earth. It further restricts the current that can flow from the molten metal layer 40 to the furnace shell 35 as well as restricting to a safe voltage (typically below 24 V) a maximum voltage that the molten metal layer 40 can reach. This is especially important for operating personnel when tapping molten metal from the furnace. It may further be used, with associated circuitry, to detect earth faults.

The first section 36.1 of the first conductor, the second section 36.2 of the first conductor and the first section 38.1 of the second conductor comprise high current busbars or bus tubes. These conductors are located in close or intimate proximity to the vessel 12, so as to closely hug the vessel.

As stated above, the electrodes 24 and 26 terminate the distance d above the upper surface 44 of the layer of slag so that, in use, a first arc 46 exists between the first electrode 24 and the body 22 of material and a second arc 48 exists between the second electrode 26 and the body of material 22.

A main DC current flows ant-clockwise from the power supply through the first conductor 36, the first electrode 24, the first arc 46, the body of material, the second arc 48, the second electrode 26 and the second conductor 38.

In FIG. 4 there is shown a second example embodiment of the furnace 10 which, in light of the description above, is self-explanatory. In this second example embodiment the first electrode is a cathode, the second electrode is an anode, the first pole is a negative pole and the second pole is a positive pole.

In FIG. 5 there is shown another example embodiment of the furnace, designated 100. Like reference numerals are used for like parts as in FIG. 1. A main difference between the furnace 100 and the furnace 10 is that the furnace 100 comprises an arc compensation conductor 102 extending continuously underneath the base parallel to the first line 28 at least across the gap g and carrying a DC compensation current in a direction A directly opposite to the direction B of DC current flowing through the body of material 40, 42 between the first electrode 24 and the second electrode 26. The conductor 102 may form part of a larger arrangement of conductors in a circuit 103 (shown in broken lines and which may have any suitable configuration) which is connected to a DC power supply 104. The DC power supply 104 may form part of the DC power supply 30 or may be a separate DC power supply. Hence, in this embodiment the arc compensation conductor 102 does not form part of any one of the first and second conductors 36 and 38, but is a separate conductor in a separate circuit 103.

1. A DC arc furnace comprising:
a vessel comprising a roof, a base and at least one sidewall extending between the roof and the base;
the vessel defining a chamber holding a body of material to be processed, the body having an upper surface;
a first electrode and a second electrode extending parallel to one another through the roof towards the base and terminating a distance d from the upper surface, the first and second electrodes, when viewed in plan, are located on a first horizontal line and define a gap g between them;
a DC power supply having a first pole and a second pole; and
a first conductor linking the first pole to the first electrode and a second conductor linking the second pole to the second electrode, the first conductor comprising a first section extending continuously underneath the base parallel to the first line at least across the gap, so that current flows in the first section in a direction directly opposite to current flowing through the body of material between the first electrode and the second electrode.

2. The DC arc furnace as claimed in claim 1 wherein the first section of the first conductor extends continuously underneath the vessel parallel to the first line from one side of the vessel to an opposite side of the vessel.

3. The DC arc furnace as claimed in claim 1 wherein the first line and the first section of the first conductor are located in a common vertical plane.

4. The DC arc furnace as claimed in claim 1 wherein the first section of the first conductor is arranged in close proximity to the base.

5. The DC arc furnace as claimed in claim 1 wherein the first section of the first conductor comprises a high current busbar or bus tube.

6. The DC arc furnace as claimed in claim 1 wherein a second section of the first conductor extends vertically upwardly from the first section towards the roof of the furnace parallel with the first electrode and in close proximity to a sidewall between the second section and the first electrode.

7. The DC arc furnace as claimed in claim 6 wherein the second section of the first conductor comprises high current busbar or bus tube.

8. The DC arc furnace as claimed in claim 1 wherein a first section of the second conductor intersects the first line and extends vertically between the base and the roof of the furnace parallel with the second electrode and in close proximity to a sidewall between the first section of the second conductor and the second electrode.

9. The DC arc furnace as claimed in claim 8 wherein the first section of the second conductor comprises high current busbar or bus tube.

10. The DC arc furnace as claimed in claim 1 wherein the first electrode is an anode, the second electrode is a cathode, the first pole is a positive pole and the second pole is a negative pole.

11. The DC arc furnace as claimed in claim 1 wherein the first electrode is a cathode, the second electrode is an anode, the first pole is a negative pole and the second pole is a positive pole.

12. The DC arc furnace as claimed in claim 1 wherein the vessel is one of circular, square and rectangular in transverse cross section.

13. The DC arc furnace as claimed in claim 1 wherein an intermediate voltage point between the first pole and the second pole of the power supply is connect via a resistor to earth.

14. A method of operating a DC arc furnace comprising: a vessel comprising a roof, a base and at least one sidewall extending between the roof and the base; the vessel defining a chamber for holding a body of material to be processed, the body having an upper surface; a first electrode and a second electrode extending parallel to one another through the roof towards the base and terminating a distance d from the upper surface, the first and second electrodes, when viewed in plan, are located on a first horizontal line and define a gap g between them; a DC power supply having a first pole and a second pole; and a first conductor linking the first pole to the first electrode and a second conductor linking the second pole to the second electrode, the method comprising the steps of:
causing a current in a first section of the first conductor to flow underneath the base in a direction opposite to current flowing through the body of material between the first electrode and the second electrode.

15. A DC arc furnace comprising:
a vessel comprising a roof, a base and at least one sidewall extending between the roof and the base;
the vessel defining a chamber holding a body of material to be processed, the body having an upper surface;
a first electrode and a second electrode extending, in a normal operative configuration, parallel to one another through the roof towards the base and terminating a distance d from the upper surface, the first and second electrodes, when viewed in plan, being located on a first horizontal line and defining a gap g between them;
a DC power supply having a first pole and a second pole; and
a first conductor linking the first pole to the first electrode and a second conductor linking the second pole to the second electrode, and
an arc deflection compensation conductor extending underneath the base and carrying a DC compensation current in a direction A opposite to the direction B of DC current flowing through the body of material between the first electrode and the second electrode.

16. The DC arc furnace as claimed in claim 15 wherein the arc deflection compensation conductor forms part of one of the first conductor and the second conductor.

17. The DC arc furnace as claimed in claim 15 wherein the arc deflection compensation conductor is separate from the first conductor and from the second conductor.
